(19) United States
(12) Patent Application Publication
(10) Pub. No.: US 2003/0191551 A1
(43) Pub. Date: Oct. 9, 2003

(54) Substrate processing system and method

(76) Inventors: Hideto Gotoh, Tsukuba-Shi (JP); Tohru Watari, Yokohama-shi (JP); Kazuyoshi Takeda, Kawasaki-shi (JP)

Correspondence Address: SLATER & MATSIL, L.L.P., 17950 PRESTON RD, SUITE 1000, DALLAS, TX, 75252-5793, US

(21) Appl. No.: 10/404,496

(22) Filed: Apr. 1, 2003

(30) Foreign Application Priority Data
Apr. 5, 2002 (JP) 2002-103196

(51) Int. Cl. G06F 19/00; G06F 7/00

(52) U.S. Cl. 700/121; 700/213; 700/228

(57) ABSTRACT

A method for transferring semiconductor wafers can suppress the generation of native oxides or watermarks, or the like, in cleaning the semiconductor wafers. In the semiconductor wafer transfer method of the preferred embodiment, first and second process chambers, and a dry unit are vertically arranged in a housing. The preferred method includes transferring the wafer between these chambers and the dry unit by a first non-contact hold type of a transfer robot, transferring the wafer between the housing and a wafer cassette by a second non-contact hold type of a transfer robot, and feeding nitrogen gas into the housing from gas-feeding inlets.

### TECHNICAL FIELD

This invention relates to a substrate processing system and method, and more particularly, to a processing system and method for performing clean processing of semiconductor wafers.

### BACKGROUND

As the dimensions of LSIs continue to shrink, the technology for cleaning semiconductor wafers has become more and more important. Important things in cleaning steps of semiconductor wafers include removing impurities such as particles or heavy materials that are generated in the preceding steps, removing chemicals that are used in the cleaning steps, and suppressing the generation of defects such as particles or watermarks in the cleaning steps. Generally, the cleaning of semiconductor wafers is wet cleaning, where the cleaning is performed using chemicals such as acid, alkaline, or organic solvent.

Typical clean processing comprises a first step of removing particles, or the like, from a silicon wafer, a second step of removing unwanted native oxides on the silicon surface, and a third step of removing heavy metals, or the like, attached to the silicon wafer, and, in each step, desired chemical cleaning is performed. In the first step, an alkaline mixture solution (hereinafter called SC-1) consisting of aqueous ammonia, hydrogen peroxide solution, and ultrapure water is used. In the second step, hydrofluoric acid diluted with ultrapure water (hereinafter called DHF (dilute hydrofluoric acid)) is used. In the third step, an acid mixture solution (hereinafter called SC-2) consisting of hydrochloric acid, hydrogen peroxide solution, and ultrapure water is used. In addition, between each of the steps, a rinse processing is performed. Finally, a complete dry is performed in a drying unit.

In the conventional wet station type system, wafers to be cleaned travel long distances between each cleaning process, and, due to the use of IPA drying, the system requires explosion-proof construction. Moreover, the throughput for wafer cleaning is suppressed because the system waits for natural displacement during the IPA drying. Because of these reasons, the generation of watermarks or native oxides cannot be avoided. Because of its large size, it is costly and impractical to keep the whole inside of the system in a nitrogen atmosphere.

Meanwhile, in the spin single-wafer cleaner type, the system has to directly contact either one of the surfaces of a silicon substrate over a wide area by means of adsorption, or the like, in transferring the wafer. Therefore, for fear of contamination, this type was thought to be inadequate, for example, in the case where the subsequent step requires extremely high cleanliness, e.g., film-forming step. Furthermore, although the wafer transfers up to the drying process can be achieved in a short time, the generation of watermarks or native oxide cannot be avoided because this type system mainly uses spin-drying. The use of the IPA is possible, however, it may cause overburden or insufficiency during the processes because of forced displacement of the IPA, and may become costly because the system requires explosion-proof construction.

FIG. 13 shows film-forming steps of a wiring layer onto a silicon substrate in the case where the conventional spin single-wafer cleaner type is used. FIG. 13(a) shows the state after an etching process is performed to form a contact hole (or via hole) 3 in an insulating film 2 (e.g. SiO₂) on a silicon substrate 1. After the etching process, unwanted materials 4, which are generated in the preceding etching process, are attached to the inner wall of the contact hole 3 in the insulating film 2, and native oxides 5 are formed on the exposed surface of the silicon substrate. Therefore, to remove the unwanted materials 4 and the native oxides 5, cleaning of the silicon wafer is performed.

FIG. 13(b) shows the state after the clean processing with chemicals. In this sate, a high cleanliness is temporally achieved by the chemical processing. However, if proper consideration is not given to drying, uneven drying can result in residual moisture 6, which will become watermarks (smears). Particularly, the higher the aspect ratio of the contact hole 3 becomes, for example, in the case where it becomes above 3, the more often watermarks are generated.

If the silicon wafer is carelessly exposed to the atmosphere after the drying step or if atmosphere control is neglected after the chemical processing, native oxides 5 are regenerated as shown in FIG. 13(c). Furthermore, remaining residual moisture becomes watermark 7. It is considered that most of them are caused by the oxygen in the atmosphere.

If film-forming of the next wiring layer is performed from this state, that is, native oxides 5 and watermark 7 are remaining in the interface between the silicon surface and a wiring layer 8 as shown in FIG. 13(d), good electrical connection of the wiring layer 8 cannot be made. This impairs the electrical reliability of the semiconductor device, and becomes the cause of failures or defects, in some cases. These problems may occur not only in the film-forming step of the wiring layer shown in FIG. 13, but may also occur in a similar way in the cleaning steps performed in other fabrication processes.

### SUMMARY OF THE INVENTION

In various aspects, the present invention can solve the above-mentioned conventional problems. For example, one embodiment of the present invention provides a semiconductor wafer processing system and method, which can fabricate highly reliable semiconductor devices by preventing the generation of native oxides or watermarks in cleaning semiconductor wafers. In another embodiment, the present invention provides a semiconductor wafer processing system and method, which can achieve both space-saving and cost reduction by arranging a plurality of clean process chambers vertically. Further, embodiments of the present invention provide an improved semiconductor substrate processing system and method, wherein the substrate to be processed is isolated from the atmosphere, and also the generation of particles or cross-contamination, or the like, during the substrate processing is suppressed.

To solve the above-mentioned and other problems, the substrate processing system of the preferred embodiment of the present invention comprises a first and a second process chamber for processing a substrate, and a transfer means for transferring the substrate between the first and second process chambers, wherein the transfer means comprises a hold means for holding the substrate substantially contactlessly under an inert gas atmosphere.

Preferably, the substrate processing system comprises a housing containing at least the first and second process chambers and the transfer means, wherein the first and second process chambers are arranged vertically in the housing, and inert gas is fed into the housing. The housing provides a space insulated from the atmosphere (a substantially sealed space), and the inert gas is preferably fed from upper portion of the housing.

In the above-mentioned system, the substrate is preferably a semiconductor wafer, and the first and second process chambers are chambers for cleaning the semiconductor wafer, and the inside of each chamber is kept under an inert gas atmosphere. Preferably, the inert gas used in the above-mentioned system is nitrogen gas. Alternatively, besides a semiconductor wafer, the system can be applicable to other substrates, such as a glass substrate for liquid crystal display, or a glass substrate for plasma display as just two examples.

Preferably, the semiconductor wafer is held and transferred substantially contactlessly by using the Bernoulli Effect. Furthermore, at least one main surface or the opposite surface of the semiconductor wafer is atmospherically controlled with nitrogen gas. Therefore, the semiconductor wafer is kept substantially under an inert gas atmosphere and is not exposed to the atmosphere, throughout the processes from the cleaning to the drying of the semiconductor wafer.

The semiconductor wafer processing system of embodiments of the present invention, wherein at least a first process chamber, a second process chamber, and a dry chamber are arranged vertically in a housing, comprises a first wafer transfer means for transferring the semiconductor wafer between the first process chamber, the second process chamber, and the dry chamber, wherein the first wafer transfer means holds the semiconductor wafer substantially contactlessly under an inert gas atmosphere.

Preferably, the first process chamber, the second process chamber, and the dry chamber are arranged in sequence from above to downward in the housing, and inert gas is fed into the housing in the direction from the first process chamber to the second process chamber. Furthermore, the semiconductor wafer processing system comprises a wafer storage portion for storing a plurality of wafers, and a second wafer transfer means for transferring the semiconductor wafers between the wafer storage portion and the first process chamber under an inert gas atmosphere and contactlessly. Since the semiconductor wafers stored in the wafer storage portion are not yet cleaned, they are contaminated with chemicals or particles, or the like, of the preceding processes. By using the first and second transfer means, the housing is isolated from the contamination in the wafer storage portion.

Preferably, the first and second process chambers are cleaning spinners for cleaning the semiconductor wafers with chemicals. In the first process chamber, an SC-1 clean is performed, and in the second process chamber, native oxides on the semiconductor wafer are removed using DHF. In addition, a third process chamber can be provided in the housing if desired. In this case, the third process chamber performs a cleaning with SC-2, for example.

Aspects of the present invention include a substrate processing method that uses a substrate processing system that comprises first and second process chambers and a dry chamber in a housing, wherein inert gas is fed into the housing. The method performs a clean processing of a substrate in the first process chamber and transfers the substrate from the first chamber to the second chamber while controlling the substrate surface substantially in an inert gas atmosphere. Further, a clean processing of the substrate in the second chamber and transferring of the substrate from the second chamber to the dry chamber while controlling the substrate surface substantially in an inert gas atmosphere is also performed.

Preferably, the first and second chambers and the dry chamber are arranged vertically and the substrate is a semiconductor wafer. In addition, the inert gas, which is fed into the housing and atmospherically controls the semiconductor wafer, is preferably nitrogen gas. Furthermore, the semiconductor wafer is held substantially contactlessly and held by using the Bernoulli Effect.

According to embodiments of the present invention, by making the size of the substrate processing system smaller, the inside of the housing can be kept in an inert gas (nitrogen gas) atmosphere at a lower cost. Because the substrate is held contactlessly by a Bernoulli chuck using inert gas, the substrate is isolated from the air in the atmosphere. Especially in the case where the substrate is a semiconductor wafer, the drying efficiency in the patterns having hole shape can be enhanced by the strong nitrogen blowing effect of the Bernoulli chuck. Moreover, the drying of semiconductor wafers can be achieved in a shorter time by using a vacuum heat drying in the dry chamber, that is, by the concomitant use of a vacuum pump and near infrared rays. In addition, by not using the chemical materials such as IPA, safety can be improved. Therefore, wafer transferring and drying technologies can be realized, which can achieve a higher throughput in a cleaning apparatus or system in a lower cost and also which do not generate watermarks or native oxides after the cleaning process. As a result, the degradation of electrical characteristics of the semiconductor devices can be suppressed and the fabrication of highly reliable semiconductors can be achieved.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a schematic block diagram showing a semiconductor wafer clean processing system according to an embodiment of the present invention;

FIGS. 2(a) through 2(d) show film-forming steps of a wiring layer using a semiconductor wafer clean processing system according to an embodiment of the present invention;

FIG. 3 is a plan view of a semiconductor wafer clean processing system according to an embodiment of the present invention;

FIG. 4 is a schematic cross-sectional view taken along line X-X of FIG. 3;

FIG. 5 is a cross-sectional view showing the structure of a wafer cassette;

FIG. 6 is a cross-sectional view showing the structure of a first clean process chamber;

FIG. 7 is a schematic elevation view showing the structure of a first transfer robot;

FIG. 8 is a schematic plan view showing the structure of a non-contact holding portion of the first transfer robot;

FIG. 9 is a cross-sectional view of the main part of FIG. 8;

FIGS. 10(a) and 10(b) show the structure of a second transfer robot; FIG. 10(a) shows a plan view and FIG. 10(b) shows an elevation view;

FIG. 11 is a schematic plan view showing the structure of a non-contact holding portion of the second transfer robot;

FIG. 12 is a side view of FIG. 11; and

FIGS. 13(a) through 13(d) show film-forming steps of a wiring layer in a conventional clean processing system.

### DETAILED DESCRIPTION OF ILLUSTRATIVE EMBODIMENTS

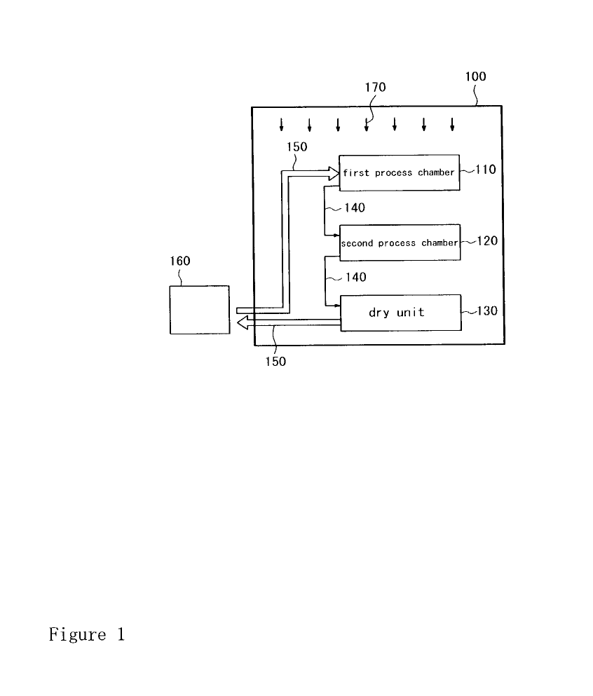

FIG. 1 is a block diagram showing the concept of a semiconductor wafer clean processing system according to an embodiment of the present invention. In FIG. 1, the clean processing system comprises a small-sized housing 100, which provides a substantially sealed space, wherein the housing 100 comprises a first process chamber 110, a second process chamber 120, and a drying unit 130. The first and the second process chambers 110 and 120, and the drying unit 130 are arranged vertically in a multi-stage configuration, and the transfers of a semiconductor wafer between these chambers and the unit are performed by a first transfer robot 140. A wafer cassette 160 stores the semiconductor wafers to be cleaned or the cleaned semiconductor wafers, and inside of the wafer cassette 160 has a configuration so that it can be purged with nitrogen gas. The wafer transfer from the wafer cassette 160 to the first process chamber 110 and the wafer transfer from the drying unit 130 to the wafer cassette 160 are performed by a second transfer robot 150. In the upper portion of the housing 100, gas-feeding inlets 170 are provided for feeding nitrogen gas into the housing.

The first process chamber 110 is a chamber for performing an SC-1 clean to remove particles, or the like, from the semiconductor wafer, and the second process chamber 120 is a chamber for performing a cleaning with DHF to remove unwanted native oxides from the semiconductor wafer surface. The inside of both the first and second process chambers 110 and 120 is kept under a nitrogen gas atmosphere. The drying unit 130 is a unit for finally drying the semiconductor wafer, which is cleaned in the second process chamber 120, and typically comprises a vacuum heat apparatus. The first and the second transfer robots 140 and 150 have functions to hold the semiconductor wafer contactlessly and control the semiconductor wafer in an inert gas atmosphere, as described later.

The semiconductor wafer, which is stored in the wafer cassette 160, is transferred one by one to the first process chamber 110 by the second transfer robot 150. The semiconductor wafer is cleaned in the first process chamber 110 to remove the unwanted materials which are generated in the preceding etching process. The semiconductor wafer is then transferred contactlessly and controlled under a nitrogen atmosphere by the first transfer robot 140 to the second process chamber 120, where unwanted native oxides are removed by using DHF. Then the wafer is transferred contactlessly and controlled under a nitrogen atmosphere by the first transfer robot 140 to the drying unit 130, where the wafer is dried. The dried semiconductor wafer is transferred contactlessly and controlled under a nitrogen atmosphere by the second transfer robot 150 to the wafer cassette 160. After a predetermined number of wafers are stored in the wafer cassette 160, the inside of the wafer cassette 160 is purged with nitrogen gas.

The semiconductor wafer clean processing system of the preferred embodiment of the present invention is characterized in that the generation of particles, or the like, is prevented by holding the semiconductor wafer contactlessly and that the semiconductor wafer is kept under a nitrogen gas atmosphere and substantially not exposed to the atmosphere. In other words, the preferred characteristic is that, from the loading of the semiconductor wafer from the wafer cassette 160 to the unloading of the semiconductor wafer back to the wafer cassette 160, the semiconductor wafer is controlled completely in a nitrogen gas atmosphere and held and transferred contactlessly.

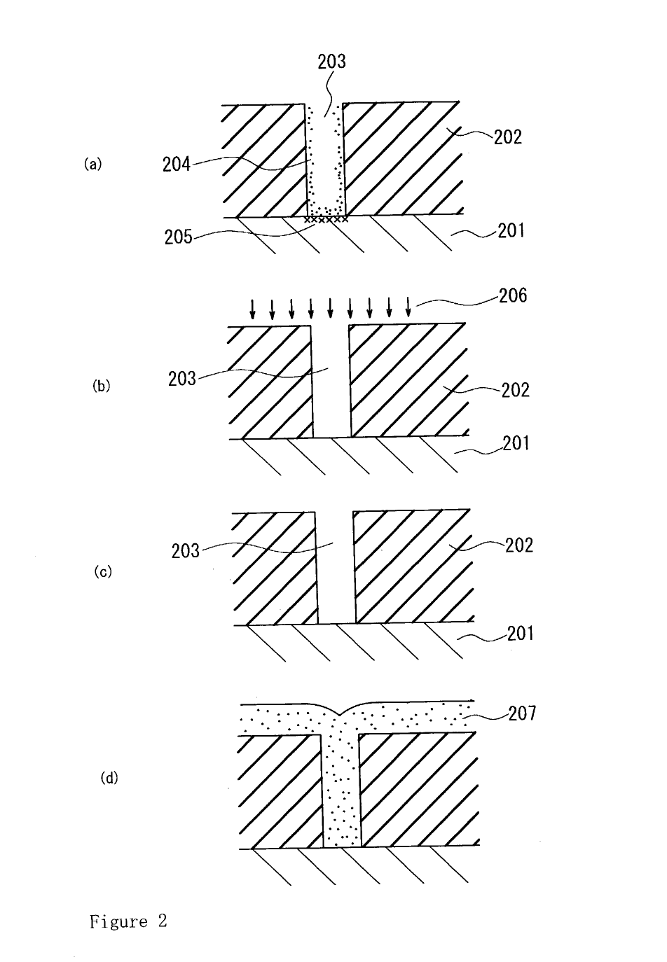

FIGS. 2(a) through 2(d) show film-forming steps of a wiring layer onto a silicon substrate using the semiconductor wafer clean processing system shown in the FIG. 1. In FIG. 2(a), an insulating film 202 of silicon oxide, for example, is applied on a silicon substrate 201, and a contact hole 203 for making electrical connections with the substrate is formed by an etching process. At this point, unwanted materials 204 are attached to the inner wall of the contact hole 203, and native oxides 205 are formed on the exposed surface of the silicon substrate. The etched semiconductor wafer is cleaned in the first process chamber 110 and the second process chamber 120, and the unwanted materials 204 and native oxides 205 are cleanly removed as shown in FIG. 2(b). In these cleanings, the semiconductor wafer surface can be maintained at high cleanliness. This is because the semiconductor wafer is substantially not exposed to the atmosphere until it is transferred to the drying unit 130 due to the facts that the semiconductor wafer is controlled in a nitrogen gas atmosphere by the transfer robot 140 during the wafer transfer, and that nitrogen blowing 206 is used in the housing 100.

Also after the wafer drying in the drying unit 130, the semiconductor wafer is transferred by the second transfer robot 150 under a nitrogen gas atmosphere and thus the wafer is not exposed in the presence of oxygen, mainly the atmosphere. Therefore, as shown in FIG. 2(c), native oxides or watermarks are rarely regenerated on the exposed surface of silicon substrate 201. As shown in FIG. 2(d), the silicon substrate 201 and a wiring layer 207 are securely electrically connected, which is a critical issue in the film-forming step of the wiring layer 207, and thus highly reliable products can be obtained.

Besides the film-forming of the wiring layer shown in FIGS. 2(a) through 2(d), it is possible to suppress the generation of watermarks in a via hole, for example, in the case where a wiring layer is formed after the formation of the via hole in a multilayer wiring structure or to prevent regeneration of native oxides on a surface of underlying polysilicon layer or silicon substrate. Needless to say, it is possible to efficiently prevent the generation of watermarks or native oxides in various clean processing other than the above-mentioned clean processing.

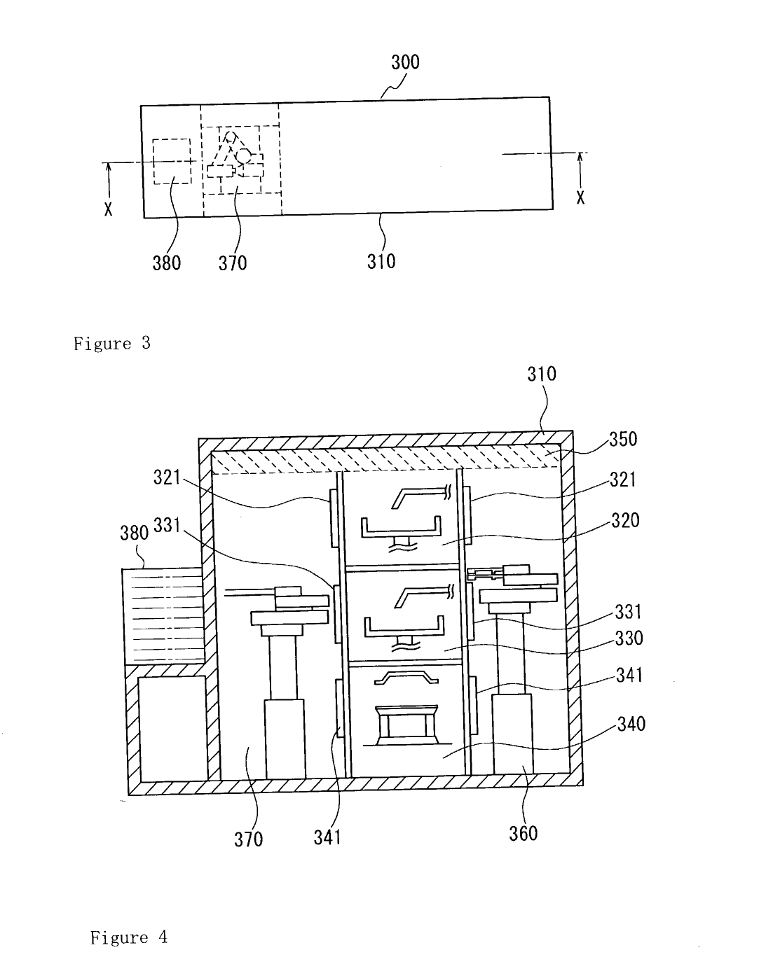

Now the structure of a semiconductor wafer clean processing system of an embodiment of the present invention will be specifically described. FIG. 3 is a plan view of a semiconductor wafer clean processing system and FIG. 4 is a schematic cross-sectional view taken along line X-X of FIG. 3. A semiconductor wafer clean processing system 300 comprises a housing 310, which has a substantially sealed space, wherein a first clean process chamber 320, a second clean process chamber 330, and a dry chamber 340 are arranged vertically to make a multi-stage configuration in the housing 310. In the upper portion of the housing 310, a HEPA filter 350 is provided for feeding nitrogen gas at a constant flow rate during the processing so that a shower of nitrogen gas is fed into the housing from above to downward during the processing. A first transfer robot 360 and a second transfer robot 370 are located respectively on each side of the process chambers 320, 330, and 340. The first transfer robot 360 performs the transfers of the semiconductor wafer between the process chambers 320, 330, and 340, and the second transfer robot 370 performs the transfers of the semiconductor wafer between a wafer cassette 380 and each of the process chambers. In this manner, by using the first and second transfer robots 360 and 370, the inside of the housing 310 can be substantially isolated from the outer contaminated environment.

On opposite surfaces of each of the process chambers 320, 330, and 340, pairs of gate valves 321, 331, and 341 are provided respectively, and the opening-and-closing operation of each gate valve allows the loading and unloading of the semiconductor wafer. The opening-and-closing operations of the gate valves 321, 331, and 341 are performed in synchronism with the movements of the transfer robot 360 or 370 under the control of a controller (not shown). The gate valves 321, 331, and 341 can be located on any one of the four surfaces of each process chamber in the housing 310 as required by the arrangements. In addition, the gate valves are not necessarily opposing each other depending on the arrangement of the transfer robots 360 and 370, and the loading and unloading of the wafer can be done by using a gate on one side only depending on the control of the controller.

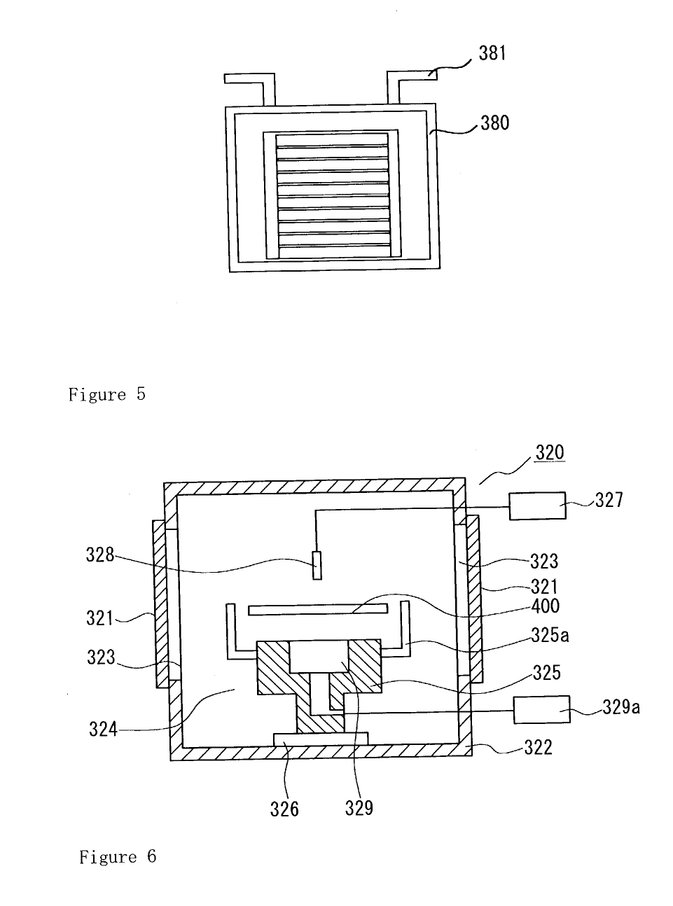

FIG. 5 shows a cross section of a wafer cassette. The pressure in a cassette 380 can be set higher than that of outside so that particles are not attached to the inside of the cassette, or a feeding inlet 381 for a nitrogen gas purge can be provided to keep the inside of the cassette under a nitrogen gas atmosphere.

FIG. 6 is a cross-sectional view showing the structure of a first clean process chamber. The second clean process chamber has an essentially similar structure to this. As shown in FIG. 6, a first clean process chamber 320 comprises a housing 322, which provides a substantially sealed space inside. On opposite surfaces of the housing 322, openings 323 are formed for loading and unloading a wafer. The openings 323 are closed by gate valves 321 during the processing. In the housing 322, a cleaning spinner 324 is provided. The cleaning spinner 324 comprises a holding table 325 for contactlessly holding a semiconductor wafer 400, a rotation-driving portion 326 for rotating the holding table, and a nozzle 328 for feeding chemical process liquid 327, for example, chemicals such as SC-1, SC-2, or DHF, and/or ultrapure water. At the center of the holding table 325, a blow-off inlet 329 is formed for blowing off nitrogen gas, and the blow-off inlet 329 is connected to a nitrogen gas feeding portion 329a for starting a gas-feeding during the processing. From the blow-off inlet 329, nitrogen gas is blown off at a constant flow rate. The nitrogen gas is blown off at one main surface of the semiconductor wafer 400 at a pressure of approximately 3.5 kg/cm, which causes some sort of Bernoulli Effect and holds the semiconductor wafer 400 substantially contactlessly above the holding table 325. On the outer periphery of the holding table 325, several wafer fixing pins 325a protrude at approximately regular intervals, which regulate the radial position of the semiconductor wafer 400. Depending on the arrangement of the transfer robot 360, by providing the gate valve in one direction only, the loading/unloading of the wafer from/to each clean process chamber can be done from the direction.

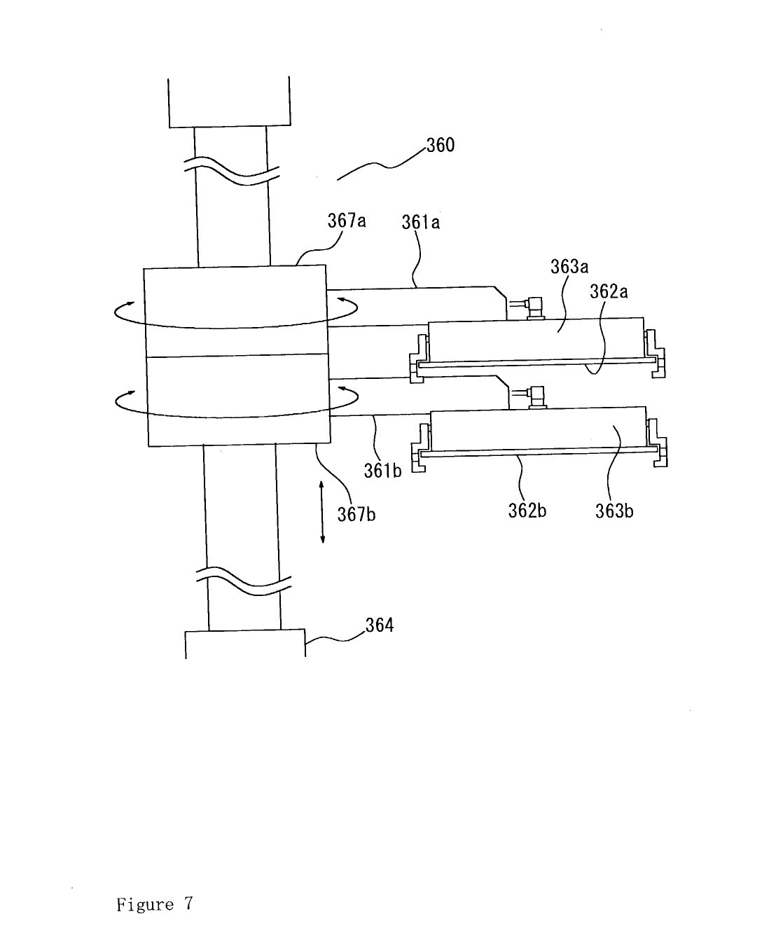

FIG. 7 shows the structure of a first transfer robot 360. Transfer robot 360 transfers each semiconductor wafer 400 one by one between each process chamber 320, 330 and 340, and therefore comprises first and second robot arms 361a, 361b and first and second non-contact holding portions 363a, 363b respectively having first and second holding surfaces 362a, 362b for holding the wafer contactlessly. The first and the second non-contact holding portions 363a, 363b are connected respectively to the first and second robot arms 361a, 361b and are rotatable by first and second driving portions 367a, 367b. The first and the second driving portions 367a, 367b are supported above a support 364 and are capable of vertical movement and rotational movement according to the instructions from a controller (not shown). Each of the holding surfaces 362a, 362b of the first and second non-contact holding portions 363a, 363b comprises a nitrogen gas blow-off inlet (see 803 in FIG. 9) so that, when the first and second holding surfaces 362a, 362b are positioned to have a predetermined distance with respect to one main surface of the semiconductor wafer, nitrogen gas is blown off from the holding surfaces 362a, 362b and thus the semiconductor wafer can be held substantially contactlessly by using the Bernoulli Effect.

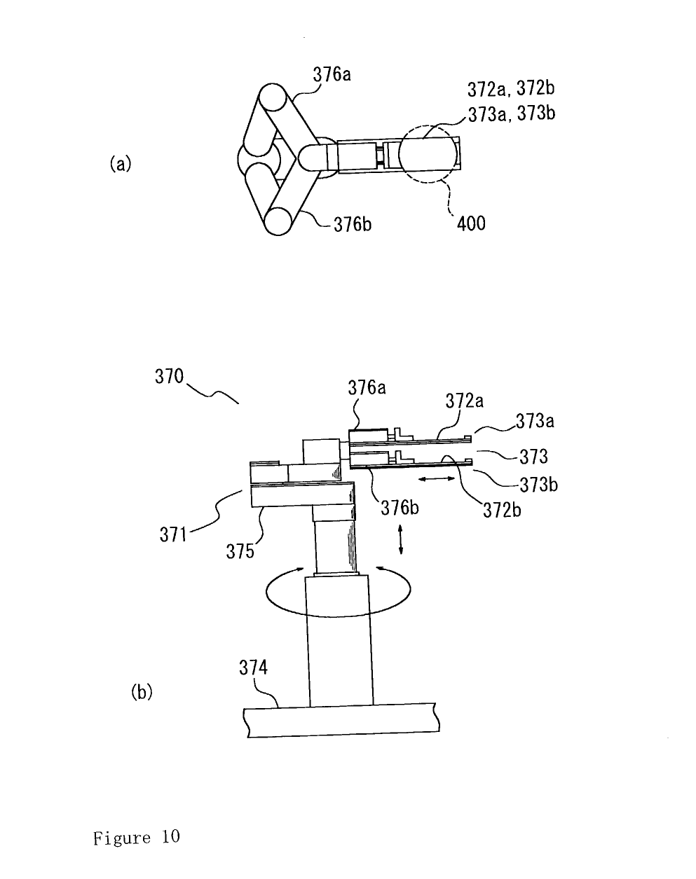

FIGS. 10(a) and (b) show the structure of a second transfer robot 370. The second transfer robot 370 transfers the wafer between a wafer cassette 380 and each process chamber in a housing, and therefore comprises a robot arm 371 and a non-contact holding portion 373. The robot arm 371 is supported above a support 374, and comprises a first arm portion 375 which is capable of vertical movement and rotational movement and second arm portions 376a, 376b which are capable of bending and extending movement. The non-contact holding portion 373 is connected to the second arm portions 376a, 376b, and is capable of moving horizontally by the movements of the first and second arm portions 375, 376a, and 376b. The non-contact holding portion 373 comprises first and second non-contact holding portions 373a, 373b of the same type. Each of the non-contact holding portion 373a, 373b has a first and a second holding surface 372a, 372b, respectively, and each of the holding surfaces 372a, 372b has a blow-off inlet for blowing off nitrogen gas. By using the Bernoulli Effect by the gas blow-off from each holding surface 372a, 372b, the semiconductor wafer can be held contactlessly. Furthermore, one main surface of the semiconductor wafer can be maintained in a nitrogen gas atmosphere, and therefore the semiconductor wafer can be isolated from the outside air.

In this embodiment, the first non-contact holding portions 363a, 373a are used for transferring the contaminated semiconductor wafer 400 in the wafer cassette 380 to the first clean process chamber 320, and, on the other hand, the second non-contact holding portions 363b, 373b are used for returning the cleaned and dried semiconductor wafer 400 back to the wafer cassette 380. In this manner, cross-contamination of the semiconductor wafer can be significantly prevented by designating the first non-contact holding portion 373a to hold and transfer the contaminated semiconductor wafer, and by designating the second non-contact holding portion 373b to hold and transfer the non-contaminated semiconductor wafer.

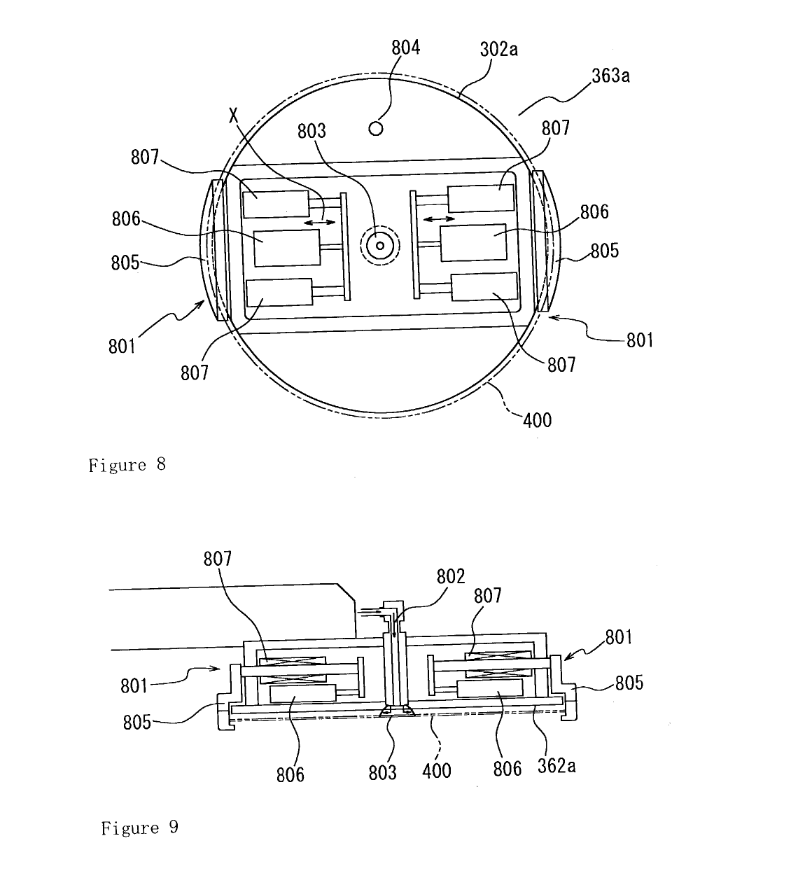

FIG. 8 is a plan view a non-contact holding portion 363a (363b) of the first transfer robot 360 and FIG. 9 is a cross-sectional view of the main part of FIG. 8. Although the structure of the first non-contact holding portion is shown here, the second non-contact holding portion has a common structure. The first non-contact holding portion 363a comprises a holding surface 362a, a mechanism 801 for regulating horizontal movement of the semiconductor wafer 400 which is contactlessly held, a gas path 802 connected to a gas blow-off inlet 803, and a light sensor 804. The mechanism 801 for regulating the movement is located in a rectangular space, which is formed by the holding surface 362a and a cover fixed to the holding surface 362a.

The holding surface 362a has a round shape having an equivalent or close equivalent size to the semiconductor wafer 400. At the center of the holding surface 362a, the blow-off inlet 803 is provided for blowing off nitrogen gas and the light sensor 804 is provided spaced a little off the blow-off inlet 803. The gas blow-off inlet 803 is communicated to the gas path 802, and the gas path 802 is connected to a gas feeder (not shown) for feeding a constant amount of nitrogen gas in holding the semiconductor wafer. Nitrogen gas is blown off from the gas blow-off inlet 803 toward the semiconductor wafer 400 to adsorb and suspend the semiconductor wafer 400.

The mechanism 801 for regulating horizontal movement of the semiconductor wafer 400 comprises a pair of claws 805, made of a material such as polytetrafluoroethylene (PTFE) or Teflon™ microcylinders 806 for opening and closing the pair of claws 805, and guides 807 for holding the claws 805. The pair of claws 805 are located on each side of the holding surface 362a, and the base portions of the claws 805 are fixed to the axes of the guides 807. The inner wall of the claw 805 has a curvature surface that is close equivalent to the curvature of the semiconductor wafer 400. The tip of the claw 805 protrudes toward inside (to the radial direction of the semiconductor wafer) and acts as a fall prevention mechanism for the semiconductor wafer 400.

The guide 807 connected to the claw 805 is capable of moving in horizontal direction X (in the right and left direction viewing the drawing) by the microcylinder 806. When the microcylinder 806 is driven by the instruction from a controller, each claw 805 is capable of moving horizontally through the guide 807, and the positions of the claws 805 are adjusted so that the suspended semiconductor wafer 400 is located in a horizontal position within a constant range. Preferably each claw 805 is positioned slightly outside of the outer periphery of the semiconductor wafer 400 and guides the semiconductor wafer 400 in a non-contact condition. In this regard, the outer periphery of the semiconductor wafer 400 does not always contact with the inner wall of the claws 805, however, the outer periphery of the semiconductor wafer 400 and the inner wall of the claws 805 contact each other in some cases to adjust the position or course of the wafer. In addition, it is possible to move the claws 805 further inward to abut against the outer periphery of the semiconductor wafer 400 and completely clamp it. The light sensor 804 detects the presence of the semiconductor wafer 400, and provides the detected result to a controller (not shown).

When nitrogen gas is blown off from the holding surface 362a of the non-contact holding portion 363a to suspend the semiconductor wafer 400 by adsorbing its upper surface by the Bernoulli Effect, there is a certain gap between the wafer and the holding surface 362a, and therefore, one main surface of the semiconductor wafer can be kept in a nitrogen gas atmosphere and the wafer is completely isolated from the atmosphere (e.g., oxygen). When the semiconductor wafer is held contactlessly, the fall of the semiconductor wafer 400 can be prevented even if the Bernoulli Effect becomes weakened, for example, by an unexpected accident during the transfer, because the claws have the fall prevention mechanism.

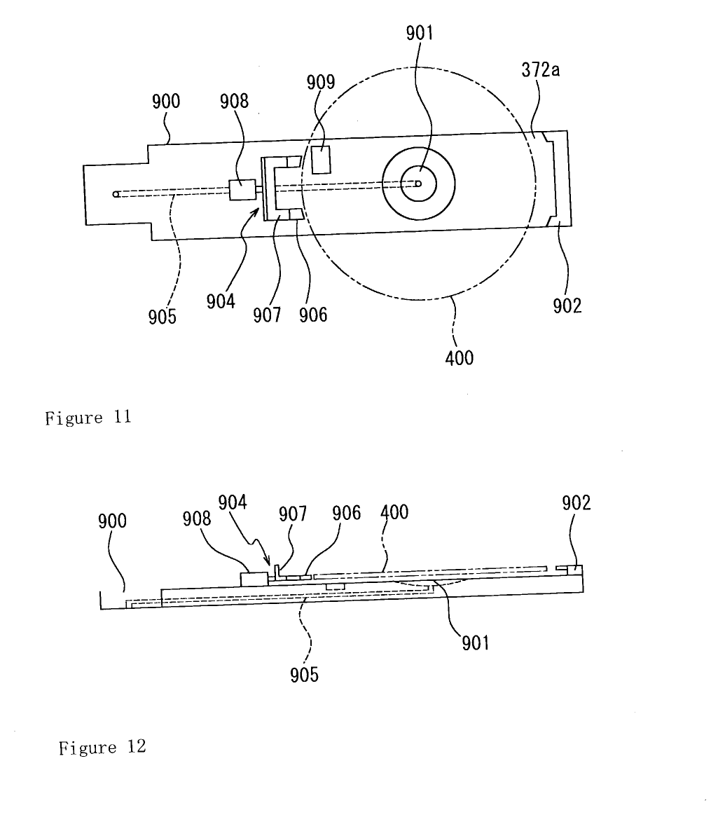

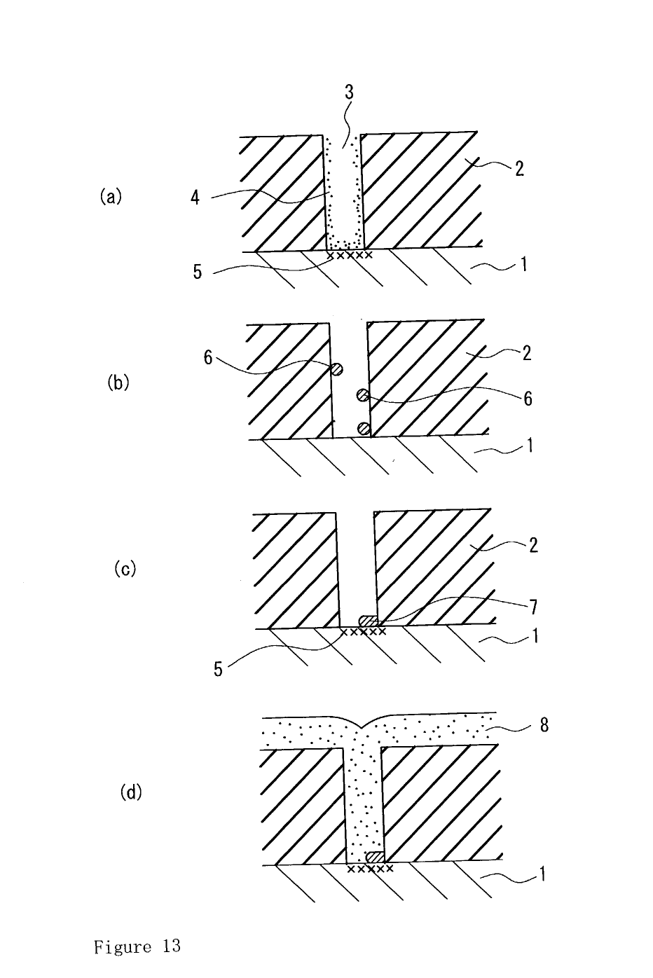

FIG. 11 is a plan view and FIG. 12 is a side view of a non-contact holding portion 373a (373b) of a second transfer robot 370. Although the structure of the first non-contact holding portion 373a is shown here, the second non-contact holding portion 373b has a common structure. The non-contact holding portion 373a comprises a rectangular holding body 900, wherein the longitudinal length of the holding body 900 is longer than the diameter of the semiconductor wafer 400, and the width in the vertical direction with respect to the longitudinal direction is shorter than the diameter. The thickness of the holding body 900 must be so thin as to be inserted between the wafers which are stored in the wafer cassette 380, optimally, not more than 3 mm. The holding surface 372a comprises a blow-off inlet 901 for blowing off nitrogen, a guide 902, made of a material such as polytetrafluoroethylene (PTFE) or Teflon™, for regulating horizontal movement of the semiconductor wafer 400 which is contactlessly held, a clamp mechanism 904 for clamping the semiconductor wafer, and a light sensor 909.

The blow-off inlet 901 is communicated to a gas path 905 which runs through the inside of the holding body 900, and the gas path 905 is connected to a gas feeder (not shown) for feeding a constant amount of nitrogen gas in holding the semiconductor wafer. The gas is blown off from the blow-off inlet 901 toward the semiconductor wafer to suspend the semiconductor wafer. The clamp mechanism 904 comprises a guide 906, made of a material such as polytetrafluoroethylene (PTFE) or Teflon™, a bracket 907 for holding the guide 906, and a microcylinder 908 for moving the bracket 907. When the microcylinder is driven by the instruction from a controller, the guide 906 abuts against the semiconductor wafer 400 through the bracket 907 and thus the wafer can be clamped. The light sensor 909 detects the presence of the semiconductor wafer, and provides the detected result to a controller (not shown).

Now, the operation of a wafer clean processing according to the present embodiment will be described. For example, etched semiconductor wafers are stored in the wafer cassette 380. The wafer is loaded one by one from the wafer cassette 380 and transferred by the first non-contact holding portion 373a of the second transfer robot 370, and then the wafer is received and transferred to the process chamber 320 by the non-contact holding portion 363a of the first transfer robot 360. The contaminated wafer in the wafer cassette 380 is held substantially contactlessly, and transferred in a controlled nitrogen atmosphere. The semiconductor wafer 400 is transferred from the first non-contact holding portion 363a through the gate valve 321 of the first process chamber 320 to the holding table 325 of the cleaning spinner 324. By positioning the first non-contact holding portion 363a above the holding table 325, and blowing off nitrogen gas from the blow-off inlet 329 of the holding table 325 and then stopping the blow-off of nitrogen gas from the non-contact holding portion 363a, the attraction of the upper surface of the semiconductor wafer from the non-contact holding portion 363a is lost, and concurrently the lower surface of the semiconductor wafer is attracted to the holding table 325, thereby the transfer is completed. The semiconductor wafer 400 is contactlessly held above the holding table 325 and rotated by the rotation-driving portion 326, and chemicals are dropped onto the wafer from the nozzle 328 to perform a clean such as the SC-1 class clean. Then, pure water is dropped from the nozzle 328 onto the wafer to perform a rinse for removing chemicals, and then the wafer is spin-dried. In this regard, the process chamber, that is, the inside of the housing 322, is kept under a nitrogen gas atmosphere, and therefore the semiconductor wafer is not exposed to the atmosphere. The loading and unloading of the wafer between the second transfer robot 370 and the first transfer robot 360 can be performed alternatively directly by the robots themselves by properly controlling the driving of the non-contact holding portions, or can be performed by commonly using a loading table which is dedicatedly provided for the transfer.

The wafer cleaned in the first process chamber 320 is then transferred to the second process chamber 330 by the first transfer robot 360. The second non-contact holding portion 363b of the first transfer robot 360 is positioned above the holding table 325 of the cleaning spinner through the gate valves 321 of the first process chamber 320. Then, nitrogen gas is blown off from the blow-off inlet 901 of the second non-contact holding portion 363b, and concurrently, the gas blow-off from the blow-off inlet 329 of the holding table 325 is stopped. Thereby, the lower surface of the semiconductor wafer loses the attraction from the holding table 325, and meanwhile, the upper surface of the wafer is attracted to the second non-contact holding portion 363b, and thus the transfer from the holding table 325 to the second non-contact holding portion 363b is completed. The wafer is transferred from the first process chamber 320 to the second process chamber 330 in the same manner, wherein the semiconductor wafer is controlled in a nitrogen gas atmosphere by the nitrogen gas blown off from the second non-contact holding portion 363b, and in the process chambers, nitrogen gas is fed through the filter 350, and therefore, the semiconductor wafer is kept under a nitrogen gas atmosphere and completely isolated from the atmosphere (e.g., oxygen).

The wafer transferred to the second clean process chamber 330 is contactlessly held by the holding table 325, and chemicals such as HF are dropped from the nozzle 328 to remove unwanted native oxides. Because the wafer is in a nitrogen gas atmosphere at this moment, the possibility of the generation of oxides on the exposed silicon surface is extremely low. The semiconductor wafer, which is rinsed and spin-dried after the processing with the above-mentioned chemicals such as HF, is transferred to the dry chamber 340 by the second transfer robot 370. The dry chamber 340 comprises a vacuum heating apparatus and heats the wafer in a vacuum condition and dries the wafer. Because the wafer is essentially not exposed to the atmosphere during the above-mentioned steps up to the dry step, regeneration of watermarks or native oxides can be prevented. Because the transferring and holding of the semiconductor wafer are performed substantially contactlessly, the generation of particles during the clean processing can be suppressed.

The semiconductor wafer 400, which is dried in the dry chamber 340, is held by the first non-contact holding portion 373a of the second transfer robot, and transferred to the wafer cassette 380. As described above, although the first non-contact holding portions 363a, 373a are always used for holding and transferring the contaminated wafer, the second non-contact holding portions 363b, 373b are used for holding and transferring the cleaned wafer. Therefore, it is possible to keep the inside of the clean processing system being isolated from the outside contaminated source and also to provide the wafer, maintaining its high cleanliness, to the succeeding steps.

It is intended that the clean processing system described above is considered as exemplary only, and it is obvious that various alterations and modifications can be made. For example, while the first and second clean process chambers and the drying chamber are vertically arranged in the present embodiment, they are not so limited. These chambers could be horizontally oriented.

Also, a third process chamber can be added. The third process chamber can be a chamber, for example, for an SC-2 class clean, that is, for removing heavy metal contamination on the wafer, and is preferably provided between the second process chamber and the dry chamber. Moreover, while the first and second process chambers and the drying chamber are arranged in this order, they can be arranged in a different order.

In addition, while the structure of the non-contact holding portions of the first transfer robot and those of the second transfer robot are different in the present embodiment, it is not so limited and two first transfer robots can be provided, or two second transfer robots can be provided alternatively.

In addition, while nitrogen gas is used as inert gas in the present embodiment it is not so limited and, for example, helium can be used. Also, a gas mixture can be used, which partly comprises gas such as nitrogen or helium. Chemicals that can be used are the chemicals comprising acid substance, alkaline substance, or fluoride, other than SC-1, DHF, and SC-2. In addition, flammable chemicals can also be used, however, if flammable chemicals are used in the present invention, fireproof or explosion-proof structure must be provided.

Furthermore, while a semiconductor wafer is used as an example in the present embodiment, not limited to semiconductor wafer, the present invention is applicable to a glass substrate for liquid crystal display or plasma display, or to other substrate processing which needs to prevent contact with the atmosphere or prevent particle generation.

As described above, according to the present invention, a substrate such as a semiconductor wafer is transferred substantially contactlessly and under in an inert gas atmosphere, therefore it is possible to isolate the substrate from the atmosphere or the like and suppress the generation of particles which are otherwise generated during the transfer, and thus avoid the defects or troubles due to the atmosphere or particles. Furthermore, by arranging process chambers vertically, space saving and miniaturization of the system can be achieved and the amount of the inert gas, which is fed in the housing, can be reduced, and thus the cost for the overall system can be reduced.

What is claimed is:

1. A substrate processing system, comprising:
a first and a second process chamber for processing a substrate; and
a transfer mechanism configured to transfer the substrate between said first and second process chambers, wherein said transfer mechanism is configured to hold said substrate substantially contactlessly under an inert gas atmosphere.

2. The substrate processing system of claim 1, wherein said substrate processing system further comprises:
a housing enclosing at least said first and second process chambers and said transfer mechanism, wherein said first and second process chambers are arranged vertically in said housing, and an inert gas is fed into said housing.

3. The substrate processing system of claim 2, wherein said housing provides a substantially sealed space, and said inert gas is fed from an upper portion of said housing.

4. The substrate processing system of claim 1, wherein said substrate processing system further comprises:
a substrate storage portion for storing a plurality of substrates; and
a second transfer mechanism for transferring the substrate between said substrate storage portion and at least one of said first and second process chambers.

5. The substrate processing system of claim 1, wherein said substrate is a semiconductor wafer, and wherein said first and second process chambers are chambers for cleaning the semiconductor wafer, and wherein the inside of each of the first and second chambers is kept substantially under an inert gas atmosphere.

6. The substrate processing system of claim 1, wherein said inert gas is a nitrogen gas.

7. The substrate processing system of claim 1, wherein said transfer mechanism holds said substrate substantially contactlessly by using the Bernoulli Effect.

8. The substrate processing system of claim 7, wherein said transfer mechanism keeps at least one main surface of the semiconductor wafer under an inert gas atmosphere.

9. The substrate processing system of claim 7, wherein said transfer mechanism keeps an opposite surface of the semiconductor wafer under an inert gas atmosphere.

10. A semiconductor wafer processing system comprising:
a first process chamber, a second process chamber, and a dry chamber arranged vertically in a housing; and
a first wafer transfer means for transferring a semiconductor wafer between said first process chamber, said second process chamber, and said dry chamber, wherein said first wafer transfer means holds the semiconductor wafer substantially contactlessly under an inert gas atmosphere while transferring the semiconductor wafer.

11. The semiconductor wafer processing system of claim 10, wherein said first process chamber, said second process chamber, and said dry chamber are arranged in sequence from above to downward in said housing, and inert gas is provided from upper portion of said housing.

12. The semiconductor wafer processing system of claim 10 and further comprising:
a wafer storage portion for storing a plurality of semiconductor wafers; and
a second wafer transfer means for transferring the semiconductor wafer between said wafer storage portion and said first process chamber.

13. The semiconductor wafer processing system of claim 10, wherein each of said first and second process chamber comprises a cleaning spinner for cleaning the semiconductor wafer, and said cleaning spinner comprises a hold means for holding the semiconductor wafer contactlessly.

14. The semiconductor wafer processing system of claim 10, wherein said semiconductor wafer processing system further comprises a third clean process chamber in the housing.

15. The semiconductor wafer processing system of claim 14, wherein the inside of said first, second and third process chambers are capable of being maintained under an inert gas atmosphere.

16. A substrate processing method, by using a substrate processing system comprising a first and a second process chambers and a dry chamber in a housing wherein inert gas is fed into said housing, the method comprising:
performing a clean processing of a substrate in the first process chamber;
transferring said substrate from the first chamber to the second chamber while maintaining the surface of said substrate substantially under an inert gas atmosphere;
performing a clean processing of the substrate in the second chamber; and
transferring said substrate from the second chamber to the dry chamber while maintaining the surface of said substrate substantially under an inert gas atmosphere.

17. The substrate processing method of claim 16, wherein said first and second chambers and dry chamber are arranged vertically.

18. The substrate processing method of claim 16, wherein said substrate is a semiconductor wafer and said inert gas which is fed into the housing and said inert gas is nitrogen gas.

19. The substrate processing method of claim 16, wherein said substrate is held and transferred substantially contactlessly in said transferring step.

20. The substrate processing method of claim 19, wherein said substrate is held contactlessly by using the Bernoulli Effect in said transferring step.
